(19) United States
(12) Patent Application Publication
(10) Pub. No.: US 2023/0114597 A1
(43) Pub. Date: Apr. 13, 2023

(54) PROCESS FOR PRODUCING A FOAM AND FOAM PART

(71) Applicant: GRAMMER AG, Ursensollen (DE)

(72) Inventor: Manfred RICHTHAMMER, Thanheim (DE)

(21) Appl. No.: 17/960,249

(22) Filed: Oct. 5, 2022

(30) Foreign Application Priority Data
Oct. 9, 2021 (DE) 10 2021 005 049.5

(51) Int. Cl. C08G 18/76; C08G 18/82; C08K 9/00; C08K 11/00; C08G 18/08; C08J 9/02

(52) U.S. Cl. CPC C08G 18/7692; C08G 18/82; C08K 9/00; C08K 11/005; C08G 18/14; C08J 9/02; C08G 2101/00

(57) ABSTRACT

A method for producing a foam, wherein polyol and an isocyanate are combined in a mold, and wherein an additive of biological matter and/or waste materials is added at the same time, before, or after, wherein the additive is pretreated.

The invention first relates to a method for producing a foam, in particular a foam of composite plastic.

DE 10 2013 108 102 A1 discloses a method for producing a mixture of biomass fibers and at least one plastic. In said method, biomass fibers of a first average particle size are provided, and the fibers are subjected to a thermal pretreatment in which they are heated for a period of time. A plastic is mixed with the thermally pretreated biomass fibers.

EP 3 812 419 describes a foam which contains a micro-fibrillated cellulose foam, a thickener, and/or a biopolymer adhesive.

The problem of stabilizing the bubbles in the foam until the foam has set is solved according to EP 3 590 905 A1 in that the surface of particles which are constituents of the foam is modified, and said particles are adsorbed to the surface of the bubbles. Stabilization additionally takes place owing to a network of particles throughout the aqueous solution.

When a foam was produced with the addition of biological additives, there was the problem that the additives caused the foam to collapse.

The object of the invention was to develop a method for producing a foam with the addition of biomass in which the problem of the collapse of the bubbles owing to the added biomass does not occur.

The object was achieved by a foam having the features of claim 1.

In the method according to the invention for producing a foam, a polyol and an isocyanate are combined in a mold. An additive of biological matter and/or waste materials is added at the same time, before, or after.

The advantage was that, for example, the foam mass becomes lighter owing to the additive. Depending on the type of additive, a stabilizing effect can be obtained, which can be the case, for example, with hay or straw. This also depends on the shape of the additive. For example, long stalks can have a more stabilizing effect than fine-ground particles in the event of tensile forces.

The hardness of the foam can be varied with different proportions of polyol and isocyanate, for example.

The proportion of the additive is, for example, between 2% and 70%, preferably 20%-30%, in particular 10%, the aforementioned information relating to the proportion of the additive by volume.

The grain sizes of the additive can vary. The length is, for example, between 1 mm and 20 mm.

Small grain sizes are advantageous. These have good processability.

Costs are saved because some of the cost-intensive foam is saved. Furthermore, waste in the form of biomass or other waste materials can be reused and does not have to be disposed of in a cost-intensive way.

The surface of the additive is pretreated, for example. This method step prevents the foam from collapsing owing to the addition of the additive.

The surface of the additive is pretreated, for example, with an isocyanate, a urea derivative, an amine, or a hydroxyl group.

It is advantageous, for example, if the surface quality is promoted by chemical docking points such as urea derivatives, isocyanates, amines, hydroxyl groups and the like.

OH groups, NH2 groups, COOH groups, inter alia, at the surface react with isocyanate, forming urea derivatives, to form groups which are furthermore reactive with isocyanate. The filler is thus modified such that it can react chemically with the foam production starting material, such that said filler is chemically integrated, which differs from a purely physical dispersion in that it is incorporated chemically in the overall product, reinforcing same, and thus can no longer be separated from the foam. If an isocyanate is used for the surface treatment of the additive, a separate substance does not have to be procured and supplied to the production process, since said substance is already provided for foam production.

The duration of the pretreatment of the surface of the parts of the additive is, for example, between 2 min and 120 min.

According to one embodiment, fats, waxes, oils, paraffins, hydrocarbons, or aromatic hydrocarbons are removed from the surface by means of pretreatment with steam and/or bases and/or acids and/or isocyanates and/or amines and/or peroxides.

A closed surface promotes the stability of the foam, for example. Furthermore, the surface should be smooth, for example. The surface should also be pressure-resistant, for example.

The isocyanate and polyol of the foam are mixed within a temperature range of 20 to 40° C., for example.

The pretreated additives are mixed with the isocyanate and polyol components of the foam within a temperature range of 25 to 40° C., for example.

With the aforementioned temperature ranges, particularly good integration of the additive into the foam and stability of the foam can be achieved.

The additive comprises, for example, one or more of the following materials: plant fibers and particles such as hay, straw, treated excrement, sewage sludge, materials originating from wood or the further processing thereof such as sawdust, lignin, materials originating from food production such as shells of nuts or pods of pulses, pressed waste materials such as pomace, shells/residues of animal products such as shells of crustaceans such as crabs, snails, fishbones, bonemeal, materials originating from paper production such as waste paper, lignin, post-consumer materials such as waste expanded glass, waste paper, bead foam residues such as expanded polystyrene, EPP, EPE.

The isocyanate is formed from a methylene diphenyl isocyanate, for example. This substance is often used in industry and is therefore easily available.

According to a second aspect, the invention relates to a foam material comprising a polyol, an isocyanate, and a pretreated additive of biological matter and/or waste materials.

The object of the invention was to develop a foam with the addition of additives in which the problem of the collapse of the bubbles owing to the added biomass does not occur.

The object was achieved by a foam having the features of claim 11.

With regard to the advantages, reference is made to the statements relating to the advantages of the method, to avoid repetitions.

The foam material is produced in particular by the method according to the first aspect of the invention.

Different embodiments of the inventions have been mentioned above. Features which are described only in relation to one exemplary embodiment can also be provided, within the scope of the invention, in any other exemplary embodiment of the invention. Such modified exemplary embodiments are also covered by the invention.

All the disclosed features are essential to the invention in themselves. The disclosure content of the cited documents and of the described prior art devices is also hereby incorporated in full in the disclosure of the application, for the purpose of including individual or multiple features of these documents in one or more claims of the present application.

1-11. (canceled)

12. A method for producing a foam, comprising the steps of:
combining polyol and an isocyanate in a mold; and
adding an additive of biological matter and/or waste materials at the same time, before, or after.

13. The method according to claim 12, including pretreating the surface of the additive.

14. The method according to claim 13, including pretreating the surface of the additive with an isocyanate, a urea derivative, an amine, a hydroxyl group.

15. The method according to claim 13, including pretreating the surface between 2 min and 120 min.

16. The method according to claim 13, including removing fats, waxes, oils, paraffins, hydrocarbons, or aromatic hydrocarbons are removed from the surface by pretreatment with steam and/or bases and/or acids and/or isocyanates and/or amines and/or peroxides.

17. The method according to claim 12, including mixing the additives isocyanate and polyol of the foam within a temperature range of 20 to 40° C.

18. The method according to claim 12, including mixing the isocyanate and polyol of the foam within a temperature range of 20 to 40° C.

19. The method according to claim 13, including mixing the pretreated additives with the isocyanate and polyol components of the foam within a temperature range of 25 to 40° C.

20. The method according to claim 12, wherein the additive comprises at least one of the following materials: plant fibers and particles, treated excrement, sewage sludge, materials originating from wood or processing of wood, materials originating from food production, pressed waste materials, shells/residues of animal products, materials originating from paper production, post-consumer materials, bead foam residues.

21. The method according to claim 20, wherein the additive is at least one of: hay, straw, treated excrement, sewage sludge, sawdust, lignin, shells of nuts or legumes, pomace, shells of crustaceans, crabs, snails, fishbones, bonemeal, waste paper, lignin, waste expanded glass, waste paper, expanded polystyrene, EPP, EPE.

22. The method according to claim 12, wherein the isocyanate is formed by a methylene diphenyl isocyanate.

23. A foam material, comprising: a polyol; an isocyanate; and a pretreated additive of biological matter and/or waste materials.
